(19) United States
(12) Patent Application Publication
(10) Pub. No.: US 2026/0114471 A1
(43) Pub. Date: Apr. 30, 2026

(54) Valve for Frozen Beverage Dispensing Equipment

(71) Applicant: IMI PLC, Federal Way, WA (US)

(72) Inventors: Tom Nguyen, Denver, CO (US); Renato Noal, Denver, CO (US)

(21) Appl. No.: 19/372,408

(22) Filed: Oct. 29, 2025

Related U.S. Application Data
(60) Provisional application No. 63/713,613, filed on Oct. 30, 2024.

(51) Int. Cl. A23G 9/28; A23G 9/22

(52) U.S. Cl. CPC A23G 9/281; A23G 9/224

(57) ABSTRACT

An example valve includes an actuator body, a linear actuator; an actuator shaft coupled to the linear actuator; a spring applying a biasing force on the actuator shaft in a distal direction; a valve body having an inlet port, an outlet port, and a seat; and a movable member mounted to the actuator shaft, wherein (i) when the linear actuator is unactuated, the spring biases the actuator shaft and the movable member in the distal direction to be seated at the seat within the valve body, thereby blocking fluid flow from the inlet port to the outlet port, and (ii) when the linear actuator is activated, the actuator shaft and the movable member move in a proximal direction, thereby forming a flow area within the valve body, allowing fluid flow from the inlet port to the outlet port.

### CROSS REFERENCE TO RELATED APPLICATION

The present application claims priority to U.S. Provisional Patent Application No. 63/713,613, filed on October 30, 2024, the entire contents of which are herein incorporated by reference as if fully set forth in this description.

### TECHINCAL FIELD

This disclosure relates generally to a valve having a composite molded valve body configured for use in fluid dispensing systems, particularly those used in food and beverage applications. The disclosed valve has a fail-safe mode and integrates several features to enhance performance, reliability, and ease of maintenance.

### BACKGROUND

A frozen beverage dispenser is configured to serve cold, slushy drinks. Such a dispenser is typically found in convenience stores, fast food restaurants, cinemas, amusement parks, etc.

Traditional valve systems used in dispensers often suffer from issues related to leakage, inconsistent flow, lack of a fail-safe mode during power loss, and complex maintenance procedures. It may thus be desirable to have a valve with integrated features that ensure a fail-safe operation, easy maintenance, and reliable performance. It is with respect to these and other considerations that the disclosure made herein is presented.

### SUMMARY

The present disclosure describes implementations that relate to a valve for frozen beverage dispensing equipment.

In a first example implementation, the present disclosure describes a valve for frozen beverage dispensing equipment. The valve includes: an actuator assembly comprising: (i) an actuator body, (ii) a linear actuator disposed within the actuator body, (iii) an actuator shaft coupled to the linear actuator, and (iv) a spring applying a biasing force on the actuator shaft in a distal direction; a valve body that is made of a molded composite food grade material, and wherein the valve body comprises an inlet port, an outlet port, and a seat; and a movable member mounted to the actuator shaft, wherein the movable member is made of a flexible thermoplastic food grade elastomer, wherein (i) when the linear actuator is unactuated, the spring biases the actuator shaft and the movable member in the distal direction to be seated at the seat within the valve body, thereby blocking fluid flow from the inlet port to the outlet port, and (ii) when the linear actuator is activated, the actuator shaft and the movable member move in a proximal direction, thereby forming a flow area within the valve body, allowing fluid flow from the inlet port to the outlet port.

In a second example implementation, the present disclosure describes a frozen beverage dispensing equipment including: a refrigeration system configured to keep a beverage mixture at a particular temperature to form ice crystals; a mixing mechanism configured to continually stir the beverage mixture to maintain a consistent texture and prevent large ice chunks from forming; one or more storage tanks that store the beverage mixture before the beverage mixture is frozen and dispensed; a dispensing nozzle configured to allow a user to pour the beverage mixture from the one or more storage tanks into a cup; and the valve of the first example implementation controlling flow of the beverage mixture from the dispensing nozzle.

In a third example implementation, the present disclosure describes a method of operating the valve of the first example implementation or the frozen beverage dispensing equipment of the second example implementation.

In a fourth example implementation, the present disclosure describes a method of assembling the valve of the first example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1A illustrates a perspective view of a frozen beverage dispensing machine, according to an example implementation.

FIG. 1B is a block diagram of the frozen beverage dispensing machine of FIG. 1A, according to an example implementation.

FIG. 2A illustrates a perspective view of a plunger valve configured to be used in a dispensing machine for frozen beverage, according to an example implementation.

FIG. 2B illustrates a perspective cross-sectional view of the plunger valve of FIG. 2A, according to an example implementation.

FIG. 3A illustrates a perspective view of a gate valve configured to be used in a dispensing machine for frozen beverage, according to an example implementation.

FIG. 3B illustrates a perspective cross-sectional view of the gate valve of FIG. 3A, according to an example implementation.

FIG. 4A illustrates a perspective view of a poppet valve configured to be used in a dispensing machine for frozen beverage, according to an example implementation.

FIG. 4B illustrates a perspective cross-sectional view of the poppet valve of FIG. 4A, according to an example implementation.

FIG. 5 is a flowchart of a method of assembling any of the valves of FIGS. 2A-2B, FIGS. 3A-3B, or FIGS. 4A-4B, according to an example implementation.

### DETAILED DESCRIPTION

Disclosed herein are systems, dispensing machines/equipment, assemblies, and methods associated with valves used in a beverage dispensing machine. The valves include a composite valve body configured to address deficiencies of traditional frozen beverage dispensing machines. Within examples, the disclosed valves have precise flow control and tight sealing capabilities to ensure that each serving is consistent in volume and quality. The valve body may be made of durable materials and integrated features that reduce the risk of leaks and contamination, thereby maintaining the hygiene and safety of the beverages.

Also, within examples, the disclosed valves have easy maintenance features, such as a bayonet attachment and quick-attach features, which may enable rapid servicing, minimizing downtime, and ensuring that the dispenser remains operational during peak service times. In examples, the disclosed valves have a pneumatic control system that simplifies operation, making it user-friendly for staff.

Thus, the disclosed valves with a composite molded valve body may enhance performance, reliability, operating in a fail-safe mode, and ease of maintenance of frozen beverage dispensers, providing a superior solution for food service establishments.

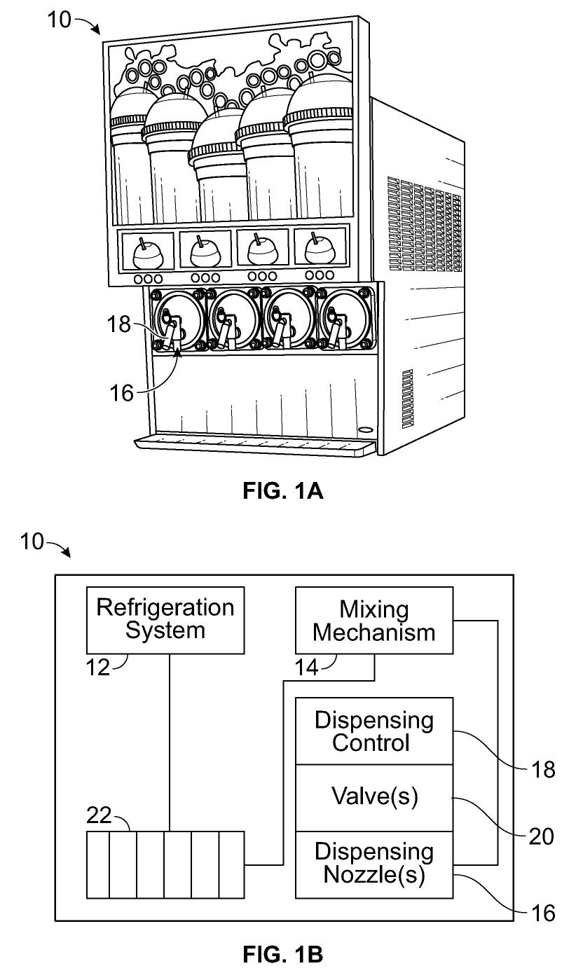

FIG. 1A illustrates a perspective view of a frozen beverage dispensing equipment 10, and FIG. 1B is a block diagram of the frozen beverage dispensing equipment 10, according to an example implementation. FIGS. 1A-1B are described together.

The frozen beverage dispensing equipment 10 includes a refrigeration system 12 that keeps a beverage mixture at the right temperature to form ice crystals, creating that slushy texture. The frozen beverage dispensing equipment 10 also includes a mixing mechanism 14 that continually stirs the beverage to maintain a consistent texture and prevent large ice chunks from forming.

The frozen beverage dispensing equipment 10 also includes one or more dispensing nozzles 16 that allow a user to pour the desired frozen beverage into a cup. For example, the frozen beverage dispensing equipment 10 may include a dispensing control 18 (e.g., buttons, levers, touchscreens, or any other input methods) to control the flow from the dispensing nozzle 16. Particularly, the dispensing control 18 may actuate respective valve(s) 20 to control dispensing the beverage from the dispensing nozzle(s) 16. The valve(s) 20 represent the internal mechanism that controls the flow of the frozen beverage.

The frozen beverage dispensing equipment 10 may also include storage tanks 22 that store the beverage mixture before it is frozen, mixed, and dispensed. The storage tanks 22 may be insulated to maintain their content at a desired cold temperature.

Operating the frozen beverage dispensing equipment 10 typically includes preparation, cooling, mixing, and dispensing. In the preparation phase, the beverage mixture (often a combination of water, syrup, and carbon dioxide for carbonated drinks) is poured into the storage tanks 22. During the cooling phase, the refrigeration system 12 cools the mixture to a temperature where it begins to freeze, forming small ice crystals.

During mixing, the mixing mechanism 14 keeps the mixture moving, ensuring a uniform slushy consistency. Then, for dispensing, a user activates the dispensing nozzle(s) 16 via the dispensing control 18, thereby actuating the valve(s) 20 causing the frozen beverage to be poured into a cup.

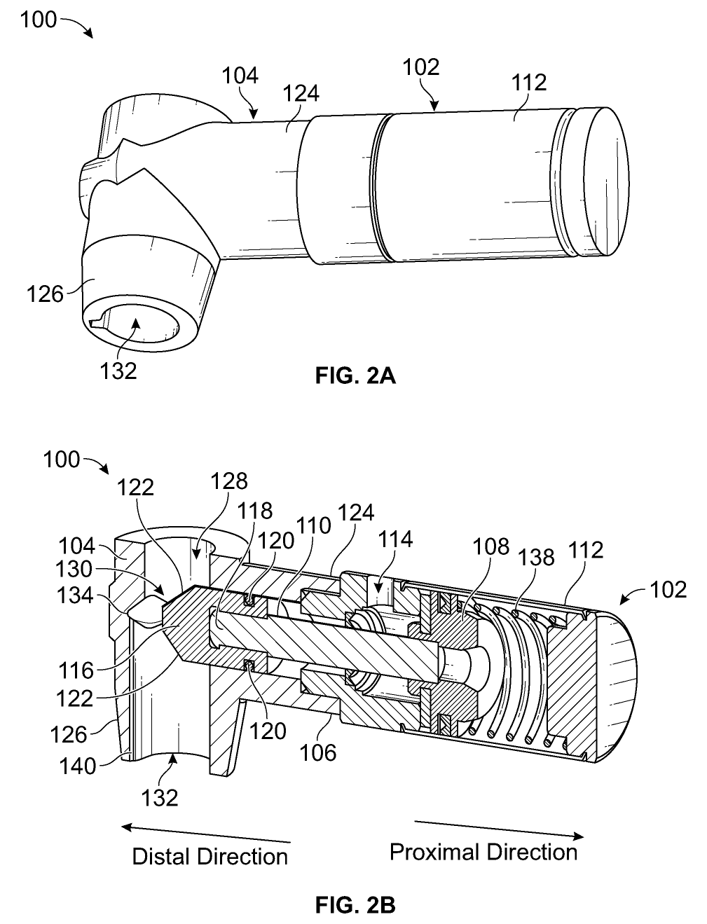

FIG. 2A illustrates a perspective view of a valve 100 configured to be used in a dispensing machine for frozen beverage, and FIG. 2B illustrates a perspective cross-sectional view of the valve 100, according to an example implementation. The valve 100 represents one of the valve(s) 20, for example. The valve 100 is configured as a plunger valve in the example implementation of FIGS. 2A-2B.

The valve 100 has an actuator assembly 102 and a valve body 104 coupled to the actuator assembly 102. The valve body 104 is configured to be made of a molded composite food grade material, for example.

Example of molded food-grade composite materials include polymer-based composites. These materials are configured to be non-toxic, durable, and non-reactive when in contact with food.

Polymer-Based Composites use a polymer as the base matrix and are reinforced or filled with other substances to achieve specific properties. For example, a starch/chitosan composite combines starch, a naturally renewable biopolymer, with chitosan, a substance with natural antimicrobial properties. The addition of chitosan can improve the material’s mechanical strength and decrease its sensitivity to water. It also provides an antimicrobial effect to help preserve the food.

As another example, a bamboo fiber/polylactic acid (PLA) composite can be used: This biodegradable composite is made from polylactic acid (a type of bioplastic) and bamboo fibers. It is non-toxic, lightweight, and has high strength, making it a sustainable replacement for traditional plastics.

In another example, the valve body 104 may be made of antimicrobial nanocomposites. These include nanoparticles or other active agents embedded within a polymer matrix to provide antimicrobial properties. The active agents, such as silver nanoparticles or essential oils, are released slowly to inhibit the growth of bacteria and fungi.

The valve 100 has a bayonet attachment 106 for coupling the valve body 104 to the actuator assembly 102. The bayonet attachment 106 may facilitate easy and quick disassembly of the actuator assembly 102 or the valve body 104 for scheduled maintenance without the need for specialized tools. For example, the bayonet attachment 106 may involve a push-and-twist and lock action or mechanism that facilitates mounting the valve body 104 to the actuator assembly 102 during assembly and also facilitates removing the valve body 104 from the actuator assembly 102 during disassembly (e.g., for maintenance or cleaning).

The actuator assembly 102 has a linear actuator 108 (e.g., a piston) operable by a single input from the user (e.g., via the dispensing control 18 such as a lever or button). Particularly, the linear actuator 108 uses a single linear force input to move a stem or an actuator shaft 110 linearly within an actuator body 112, thereby simplifying the control mechanism and reducing system complexity. The linear actuation can be powered by different pneumatic pressurized media, manual force, hydraulic, or electric sources, including solenoids or motors.

As an example, the actuator body 112 may have a port 114 that allows a pneumatic connection to be made with the actuator assembly 102 to provide gas thereto and actuate the linear actuator 108 to move the actuator shaft 110. With this configuration, the actuator body 112 may be configured as an integrated fitting cartridge with a low-profile pneumatic connection at the port 114. This may allow for compact and efficient pneumatic connections, reducing the overall footprint of the valve 100.

The valve 100 further includes a movable member configured as a plunger 116 mounted to the actuator shaft 110. Particularly, the plunger 116 may be attached or mounted to the actuator shaft 110 via a quick-attach feature 118 (e.g., dovetail, snap configuration, etc.) that enables rapid assembly and disassembly, improving maintenance efficiency.

The plunger 116 can be configured as a one-piece molded component made from a food grade thermoplastic elastomer, e.g., a material certified by the National Sanitation Foundation (NSF) for use in food equipment. Particularly, the plunger 116 may be made of a flexible thermoplastic elastomer that ensures a tight seal with the valve body 104 as described below.

As the plunger 116 is made of a flexible material, it can self-adjust its position to form a reliable seal. Also, the plunger 116 may have a low surface energy to resist adhesive sticking. The plunger 116 thus meets food safety standards, and provides a durable, hygienic seal.

A low surface energy (LSE) material is a material that has a weak molecular attraction at its surface, making it difficult for liquids, like adhesives or paints, to spread out and “wet” the surface. This makes such material suitable for the plunger 116 as its non-stick or non-adhesive properties are desirable in this particular valve configuration. Such material may cause the beverage to form beads or droplets because the molecules are more attracted to each other than to the surface of the plunger 116.

Examples of low surface energy materials include polymers and are characterized by a surface energy value typically below 36 dynes/centimeter (cm). For instance, the plunger 116 may be made of fluoropolymers, which includes polytetrafluoroethylene (PTFE). Its non-stick properties are a direct result of its low surface energy.

Other example materials include polyolefins. This group of plastics includes polypropylene (PP) and polyethylene (PE). They tend to have high resistance to chemicals.

Another example materials include silicone, which is a synthetic polymer with rubber-like properties. Silicone is heat-resistant and has low surface energy, making it an a proper material for the plunger 116 in this application.

Other suitable plastics include polystyrene (PS), acetal (polyoxymethylene/POM), and nylon, which are all also considered lower surface energy materials due to their molecular structure. In other examples, powder-coated paints may be used. The additives in these paints can create a low surface energy finish, which provides a durable, protective coating to the plunger 116.

In another example, thermoplastic polyester elastomers (TPC-ET) can be used. Such material might be expensive, and as such, the plunger 116 could be made of a rubber core that might be inexpensive, surrounded by layer of TPC-ET.

As shown in FIG. 2B, the plunger 116 may have an external annular groove in which a radial seal 120 is disposed. The radial seal 120 is configured as an integrated molded wiper seal disposed around the plunger 116 to seal and isolate wetted areas between the valve body 104 and the actuator assembly 102, preventing contamination and ensuring smooth operation.

Particularly, as the plunger 116 moves axially/longitudinally within the valve body 104, the radial seal 120 can wipe any fluid stuck to the interior surface of the valve body 104, and may prevent leakage of such fluid to the actuator assembly 102. Further, a tapered profile 122 of the plunger 116 may facilitate forming a tight seal with the interior surface of the valve body 104 (with seat 134 described below), ensuring a drip-free seal and enhancing the reliability of the dispensing system.

The valve body 104 has a longitudinal portion 124 and a transversal portion 126. The longitudinal portion 124 is coupled to the actuator assembly 102 via the bayonet attachment 106 mentioned above and is aligned longitudinally or axially with the actuator assembly 102. The longitudinal portion 124 is thus parallel to or aligned with the axial direction of motion of the actuator shaft 110 and the plunger 116.

The transversal portion 126 is substantially perpendicular to the longitudinal portion 124 and the actuator assembly 102. The transversal portion 126 defines or has an inlet port 128 through which a beverage is allowed to flow into an internal chamber 130 of the transversal portion 126. The transversal portion 126 also has an outlet port 132 through which fluid in the internal chamber 130 is discharged to a cup of a user dispensing fluid from the dispensing machine having the valve 100.

The transversal portion 126 has a receptacle, notch, or seat 134 having a tapered interior surface as shown in FIG. 2B. The plunger 116 has a corresponding tapered exterior surface 136 (of the tapered profile 122). When the actuator shaft 110 and the plunger 116 mounted thereto are fully-extended in the distal direction, the plunger 116 is partially received within the seat 134. The corresponding tapered exterior surface 136 thus interfaces with the corresponding tapered interior surface of the seat 134, facilitating self-centering of the plunger 116 within the seat 134, and forming a tight seal in ice and slushy environments.

In an example, the valve 100 is configured as a normally-closed (NC) valve. Particularly, the actuator assembly 102 may a spring 138 that biases the linear actuator 108, and the actuator shaft 110, and the plunger 116 mounted thereto in the distal direction to a closed position or closed state. With this configuration, when the valve 100 is not actuated (e.g., when no pressurized fluid is provided to the port 114), the spring 138 biases the plunger 116 toward the seat 134, thereby blocking fluid flow from the inlet port 128 to the outlet port 132. Thus, the valve 100 has a fail-safe mode in which the spring 138 ensures the valve 100 remains closed in the event of a system failure, preventing unintended fluid flow.

In an example, the transversal portion 126 of the valve body 104 may have a recess or slot 140 formed in the transversal portion 126. The slot 140 facilitates venting fluid to the outlet port 132 when the plunger 116 is seated within the seat 134 at the end of the stroke of the actuator shaft 110. Such venting may eliminate hydraulic lock at the end of the stroke of the plunger 116 and the actuator shaft 110. The slot 140 may also allow air to enter and circulate in the transversal portion 126 and facilitate causing any remaining beverage to be discharged as opposed to staying and melting.

During operation, a user of a dispensing machine may press a button or move a lever (e.g., use the dispensing control 18) to actuate the valve 100. Upon actuating the valve 100, the actuator assembly 102 may be activated. For example, pressurized fluid (e.g., air or gas) may be provided to the port 114, thereby causing the linear actuator 108 (and actuator shaft 110) to retract (e.g., move in the proximal direction). As a result, the plunger 116 moves with the actuator shaft 110, thereby being unseated from the seat 134 and forming a flow orifice or flow area (as depicted in FIG. 2B) between the plunger 116 and the interior surface of the transversal portion 126 of the valve body 104.

The size of the flow area can be precisely controlled by the actuator assembly 102 and the linear position of the plunger 116. In this manner, the valve 100 provides precise control over the fluid flow rate, allowing for consistent dispensing.

Other valve implementations are contemplated herein. For example, rather than using a plunger valve implementation, a gate valve implementation may be used.

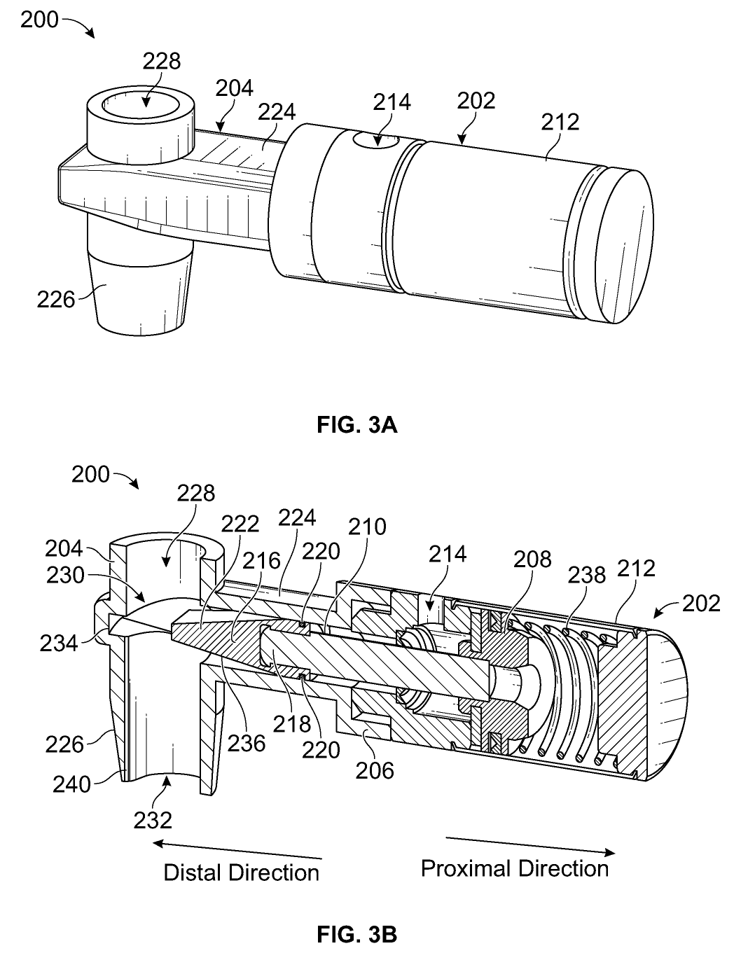

FIG. 3A illustrates a perspective view of a valve 200 configured to be used in a dispensing machine for frozen beverage, and FIG. 3B illustrates a perspective cross-sectional view of the valve 200, according to an example implementation. The valve 200 is generally similar to the valve 100 but is configured as a gate valve having a movable member configured as a gate valve blade rather than a plunger.

The valve 200 has an actuator assembly 202 and a valve body 204 coupled to the actuator assembly 202. The valve body 204 is configured to be made of a molded composite food grade material, for example (e.g., the same materials described above with respect to the valve body 104).

The valve 200 has a bayonet attachment 206 for coupling the valve body 204 to the actuator assembly 202. The bayonet attachment 206 may facilitate easy and quick disassembly of the actuator assembly 202 or the valve body 204 for scheduled maintenance without the need for specialized tools. For example, the bayonet attachment 206 may involve a push-and-twist and lock action or mechanism that facilitates mounting the valve body 204 to the actuator assembly 202 during assembly, and also facilitates removing the valve body 204 from the actuator assembly 202 during disassembly (e.g., for maintenance of cleaning).

The actuator assembly 202 has a linear actuator 208 (e.g., piston) operable by a single input from the user (e.g., via the dispensing control 18 such as a lever or button). Particularly, the linear actuator 208 uses a single linear force input to move an actuator shaft 210 linearly within an actuator body 212, thereby simplifying the control mechanism and reducing system complexity. The linear actuation can be powered by different pneumatic pressurized media, manual force, hydraulic, or electric sources, including solenoids or motors.

As an example, the actuator body 212 may have a port 214 that allows a pneumatic connection to be made with the actuator assembly 202 to provide gas thereto and actuate the actuator shaft 210. With this configuration, the actuator body 212 may be configured as an integrated fitting cartridge with a low-profile pneumatic connection, which may allow for compact and efficient pneumatic connections, reducing the overall footprint of the valve 200.

The valve 200 further includes a movable member configured as a blade 216 (a gate valve blade) mounted to the actuator shaft 210. Particularly, the blade 216 may be attached or mounted to the actuator shaft 210 via a quick-attach feature 218 (e.g., dovetail, snap configuration, etc.) that enables rapid assembly and disassembly, improving maintenance efficiency.

The blade 216 can be configured as a one-piece molded component made from a food grade thermoplastic elastomer, e.g., a material certified by the NSF for use in food equipment. Particularly, the blade 216 may be made of a flexible thermoplastic elastomer (e.g., any of the materials described above with respect to the plunger 116) that ensures a tight seal with the valve body 204 as described below.

As the blade 216 is made of a flexible material, it can self-adjust its position to form a reliable seal. Also, the blade 216 may have low surface energy, similar to the plunger 116, to resist adhesive sticking. The blade 216 thus meets food safety standards, and provides a durable, hygienic seal.

As shown in FIG. 3B, the blade 216 may have an external annular groove in which a radial seal 220 is disposed. The radial seal 220 is configured as an integrated molded wiper seal disposed around the blade 216 to seal and isolate wetted areas between the valve body 204 and the actuator assembly 202, preventing contamination and ensuring smooth operation.

Particularly, as the blade 216 moves axially/longitudinally within the valve body 204, the radial seal 220 can wipe any fluid stuck to the interior surface of the valve body 204, and may prevent leakage of such fluid to the actuator assembly 202. Further, a tapered profile 222 of the blade 216 may facilitate forming a tight seal with the interior surface of the valve body 204 (with seat 234 described below), ensuring a drip-free seal and enhancing the reliability of the dispensing system.

The valve body 204 has a longitudinal portion 224 and a transversal portion 226. The longitudinal portion 224 is coupled to the actuator assembly 202 via the bayonet attachment 206 mentioned above and is aligned longitudinally or axially with the actuator assembly 202. The longitudinal portion 224 is thus parallel to or aligned with the axial direction of motion of the actuator shaft 210 and the blade 216.

The transversal portion 226 is substantially perpendicular to the longitudinal portion 224 and the actuator assembly 202. The transversal portion 226 defines or has an inlet port 228 through which a beverage is allowed to flow into an internal chamber 230 of the transversal portion 226. The transversal portion 226 also has an outlet port 232 through which fluid in the internal chamber 230 is discharged to a cup of a user dispensing fluid from the dispensing machine having the valve 200.

The transversal portion 226 has a receptacle, notch, or seat 234 having a tapered interior surface as shown in FIG. 3B. The blade 216 has a corresponding tapered exterior surface 236. When the actuator shaft 210 and the blade 216 mounted thereto are fully extended in the distal direction, the blade 216 is partially received within the seat 234. The corresponding tapered exterior surface 236 thus interfaces with the corresponding tapered interior surface of the seat 234, facilitating self-centering of the blade 216 within the seat 234, and forming a tight seal in ice and slushy environments.

In an example, the valve 200 is configured as an NC valve. Particularly, the actuator assembly 202 may a spring 238 that biases the actuator shaft 210 and the blade 216 mounted thereto in the distal direction. With this configuration, when the valve 200 is not actuated (e.g., when no pressurized fluid is provided to the port 214), the spring 238 biases the blade 216 toward the seat 234, thereby blocking fluid flow from the inlet port 228 to the outlet port 232. Thus, the valve 200 has a fail-safe mode in which the spring 238 ensures the valve 200 remains closed in the event of a system failure, preventing unintended fluid flow.

In an example, the transversal portion 226 of the valve body 204 may have a recess or slot 240 formed in the transversal portion 226. The slot 240 facilitates venting fluid to the outlet port 232 when the blade 216 is seated within the seat 234 at the end of the stroke of the actuator shaft 210. Such venting may eliminate hydraulic lock at the end of the stroke of the blade 216 and the actuator shaft 210.

During operation, a user of a dispensing machine may press a button or move a lever to actuate the valve 200. Upon actuating the valve 200, the actuator assembly 202 may be activated. For example, pressurized fluid (e.g., air or gas) may be provided to the port 214, thereby causing the actuator shaft 210 to retract (e.g., move in the proximal direction). As a result, the blade 216 moves with the actuator shaft 210, thereby being unseated from the seat 234 and forming a flow orifice or flow area between the blade 216 and the interior surface of the transversal portion 226 of the valve body 204.

The size of the flow area can be precisely controlled by the actuator assembly 202 and the linear position of the blade 216. In this manner, the valve 200 provides precise control over the fluid flow rate, allowing for consistent dispensing.

In another example implementation, a poppet valve configuration may be used where the movable member is a poppet.

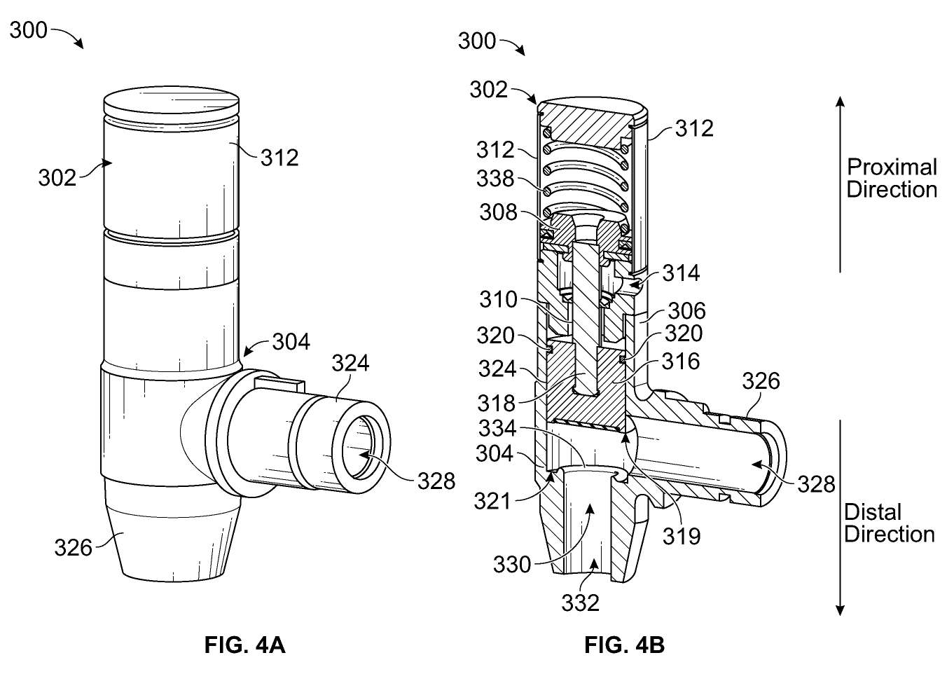

FIG. 4A illustrates a perspective view of a valve 300 configured to be used in a dispensing machine for frozen beverage, and FIG. 4B illustrates a perspective cross-sectional view of the valve 300, according to an example implementation. The valve 300 is configured as a poppet valve having a poppet as the movable member controlling flow of fluid.

The valve 300 has an actuator assembly 302 and a valve body 304 coupled to the actuator assembly 302. The valve body 304 is configured to be made of a molded composite food grade material, for example (e.g., the same materials described above with respect to the valve body 104).

The valve 300, and particularly the valve body 304, is generally tee-shaped and has a bayonet attachment 306 for coupling the valve body 304 to the actuator assembly 302. The bayonet attachment 306 may facilitate easy and quick disassembly of the actuator assembly 302 or the valve body 304 for scheduled maintenance without the need for specialized tools. For example, the bayonet attachment 306 may involve a push-and-twist and lock action or mechanism that facilitates mounting the valve body 304 to the actuator assembly 302 during assembly, and also facilitates removing the valve body 304 from the actuator assembly 302 during disassembly (e.g., for maintenance of cleaning).

The actuator assembly 302 has a linear actuator 308 (e.g., piston) operable by a single input from the user (e.g., via the dispensing control 18 such as a lever or button). Particularly, the linear actuator 308 uses a single linear force input to move an actuator shaft 310 linearly within an actuator body 312, thereby simplifying the control mechanism and reducing system complexity. The linear actuation can be powered by different pneumatic pressurized media, manual force, hydraulic, or electric sources, including solenoids or motors.

As an example, the actuator body 312 may have a port 314 that allows a pneumatic connection to be made with the actuator assembly 302 to provide gas thereto and actuate the actuator shaft 310. With this configuration, the actuator body 312 may be configured as an integrated fitting cartridge with a low-profile pneumatic connection, which may allow for compact and efficient pneumatic connections, reducing the overall footprint of the valve 300.

The valve 300 further includes a movable member configured as a poppet 316 mounted to the actuator shaft 310. Particularly, the poppet 316 may be attached or mounted to the actuator shaft 310 via a quick-attach feature 318 (e.g., dovetail, snap configuration, etc.) that enables rapid assembly and disassembly, improving maintenance efficiency.

The poppet 316 can be configured as a one-piece molded component made from a food grade thermoplastic elastomer, e.g., a material certified by the NSF for use in food equipment. Particularly, the poppet 316 may be made of a flexible thermoplastic elastomer (e.g., any of the materials described above with respect to the plunger 116) that ensures a tight seal with the valve body 304 when seated as described below.

As the poppet 316 is made of a flexible material, it can self-adjust its position to form a reliable seal. Also, the poppet 316 may have a low surface energy to resist adhesive sticking. The poppet 316 thus meets food safety standards, and provides a durable, hygienic seal.

As shown in FIG. 4B, the poppet 316 may have an external annular groove in which a radial seal 320 is disposed. The radial seal 320 is configured as an integrated molded wiper seal disposed around the poppet 316 to seal and isolate wetted areas between the valve body 304 and the actuator assembly 302, preventing contamination and ensuring smooth operation.

Particularly, as the poppet 316 moves axially/longitudinally within the valve body 304, the radial seal 320 can wipe any fluid stuck to the interior surface of the valve body 304, and may prevent leakage of such fluid to the actuator assembly 302. Further, the poppet 316 has a distal annular protrusion 319 (e.g., rim or flange) that is configured to be received within an annular groove 321 formed in the valve body 304 to form a tight seal with the interior surface of the valve body 304, ensuring a drip-free seal and enhancing the reliability of the dispensing system.

As mentioned above, the valve body 304 may be tee-shaped having a longitudinal portion 324 and a transversal portion 326. The longitudinal portion 324 is coupled to the actuator assembly 302 via the bayonet attachment 306 mentioned above and is aligned longitudinally or axially with the actuator assembly 302. The longitudinal portion 324 is thus parallel to or aligned with the axial direction of motion of the actuator shaft 310 and the poppet 316.

The transversal portion 326 is substantially perpendicular to the longitudinal portion 324 and the actuator assembly 302. The transversal portion 326 defines or has an inlet port 328 through which a beverage is allowed to flow into an internal chamber 330 of the transversal portion 326. The longitudinal portion 326 has an outlet port 332 through which fluid in the internal chamber 330 is discharged to a cup of a user dispensing fluid from the dispensing machine having the valve 300.

When the actuator shaft 310 and the poppet 316 mounted thereto are fully extended in the distal direction, the distal annular protrusion 319 of the poppet 316 is received within the annular groove 321, which is configured as a receptacle for the distal annular protrusion 319. In such position, the poppet 316 is seated at a seat 334 formed in the valve body 304. This configuration may facilitate self-centering of the poppet 316 relative to the valve body 304, and forming a tight seal in ice and slushy environments.

In an example, the valve 300 is configured as an NC valve. Particularly, the actuator assembly 302 may a spring 338 that biases the actuator shaft 310 and the poppet 316 mounted thereto in the distal direction. With this configuration, when the valve 300 is not actuated (e.g., when no pressurized fluid is provided to the port 314), the spring 338 biases the poppet 316 toward the seat 334, thereby blocking fluid flow from the inlet port 328 to the outlet port 332. Thus, the valve 300 has a fail-safe mode in which the spring 338 ensures the valve 300 remains closed in the event of a system failure, preventing unintended fluid flow.

During operation, a user of a dispensing machine may press a button or move a lever to actuate the valve 300. Upon actuating the valve 300, the actuator assembly 302 may be activated. For example, pressurized fluid (e.g., air or gas) may be provided to the port 314, thereby causing the actuator shaft 310 to retract (e.g., move in the proximal direction). As a result, the poppet 316 moves with the actuator shaft 310, thereby being unseated from the seat 334 and forming a flow orifice or flow area between the poppet 316 and the interior surface of the transversal portion 326 of the valve body 304.

The size of the flow area can be precisely controlled by the actuator assembly 302 and the linear position of the poppet 316. In this manner, the valve 300 provides precise control over the fluid flow rate, allowing for consistent dispensing.

Thus, the valves 100, 200, 300 may provide several advantages. The valve body 104, 204, 304 being made from a molded composite material is configured to integrate multiple features that enhance its performance and ease of maintenance. The valve body 104, 204, 304 is constructed from a durable, food-grade thermoplastic elastomer that meets NSF standards, ensuring safety and hygiene in food and beverage applications.

Each valve of the valves 100, 200, 300 (plunger, gate, and poppet valve configurations) incorporates an integrated spring-based fail-safe mode, rendering the valve normally closed to ensure the valve remains closed in the event of a system failure, preventing unintended fluid flow. Controlling the linear position of the movable member (e.g., the plunger 116, the blade 216, the poppet 316) controls a size of an orifice or flow area formed within the valve body, thereby enabling precise control over the fluid flow rate, ensuring consistent dispensing.

The push-and-twist and lock bayonet attachment mechanism (e.g., the bayonet attachment 106, 206, 306) between the valve body and actuator assembly facilitates disassembly for scheduled maintenance, while the integrated fitting cartridges with low profile pneumatic connections reduce the overall footprint of the valve.

Further, the quick-attach configuration (e.g., dovetail, snap configuration, etc.) between the movable member (e.g., the plunger 116, the blade 216, the poppet 316) and the actuator shaft 110, 210, 310 may enable rapid assembly and disassembly, improving maintenance efficiency. The one-piece molded food grade thermoplastic elastomer construction of the movable member provides a durable, hygienic seal, while the integrated molded wiper seals (the radial seal 120, 220, 320) isolates wetted areas between the movable member and the actuator, preventing contamination.

Further, the tapered profile 122, 222 of the plunger 116 and the blade 216, respectively, may ensure tight, drip-free sealing, enhancing the reliability of the dispensing system. The self-centering action of the movable member with the valve body may improve the valve’s performance and longevity.

For the valve 300, the profile of the seat 334 may provide the lowest level of surface contact necessary to ensure the function while avoiding stickiness of the fluid between the poppet 316 and the valve body 304. Further, the movable member (e.g., the plunger 116, the blade 216, and the poppet 316) are made of a compliant thermoplastic elastomer material that provides tight sealing over the life of the equipment, low surface energy, with unique surface characteristics, making them harder for pressure sensitive adhesives medias to stick and self-compensating/adjusting to increase the equipment’s reliability.

Also, in the example wherein linear pneumatic control is used, such control may be operated with a single input, simplifying the control mechanism and reducing the complexity of the system. Further, the linear actuation can be done by other sources of force such as manual, hydraulic and electric by solenoid or motor.

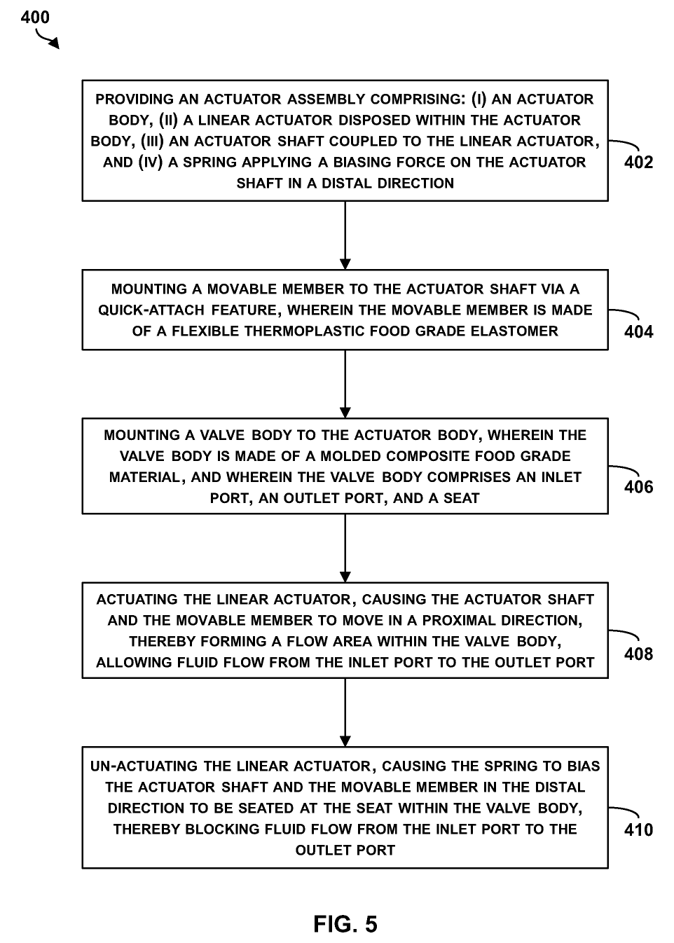

FIG. 5 is a flowchart of a method 400 of assembling any of the valves 100, 200, 300, according to an example implementation.

The method 400 may include one or more operations, functions, or actions as illustrated by one or more of blocks 402-510. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 402, the method 400 includes providing the actuator assembly 102, 202, 302 comprising: (i) the actuator body 112, 212, 312, (ii) the linear actuator 108, 208, 308 disposed within the actuator body 112, 212, 312, (iii) the actuator shaft 110, 210, 310 coupled to the linear actuator 108, 208, 308, and (iv) the spring 138, 238, 338 applying a biasing force on the actuator shaft 110, 210, 310 in the distal direction.

The term “providing” as used herein, and for example regarding the actuator assembly, includes any action to make the actuator assembly available for use, such as bringing the actuator assembly to an apparatus or to a work environment for further processing (e.g., mounting other components).

At block 404, the method 400 includes mounting a movable member (e.g., the plunger 116, the blade 216, or the poppet 316) to the actuator shaft 110, 210, 310 via a quick-attach feature, wherein the movable member is made of a flexible thermoplastic food grade elastomer.

At block 406, the method 400 includes mounting the valve body 104, 204, 304 to the actuator body 112, 212, 312, wherein the valve body 104, 204, 304 is made of a molded composite food grade material, and wherein the valve body 104, 204, 304 comprises the inlet port 128, 228, 328, the outlet port 132, 232, 332, and the seat 134, 234, 334.

At block 408, the method 400 includes actuating the linear actuator 108, 208, 308, causing the actuator shaft 110, 210, 310 and the movable member to move in the proximal direction, thereby forming a flow area within the valve body 104, 204, 304, allowing fluid flow from the inlet port 128, 228, 328 to the outlet port 132, 232, 332.

At block 410, the method 400 includes un-actuating (via deactivating or turning off the an actuation mechanism of the valve) the linear actuator 108, 208, 308, causing the spring 138, 238, 338 to bias the actuator shaft 110, 210, 310 and the movable member in the distal direction to be seated at the seat 134, 234, 334 within the valve body 104, 204, 304, thereby blocking fluid flow from the inlet port 128, 228, 328 to the outlet port 132, 232, 332.

The method 400 can further include any of the other steps or operations described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those with skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a valve for frozen beverage dispensing equipment, the valve comprising: an actuator assembly comprising: (i) an actuator body, (ii) a linear actuator disposed within the actuator body, (iii) an actuator shaft coupled to the linear actuator, and (iv) a spring applying a biasing force on the actuator shaft in a distal direction; a valve body that is made of a molded composite food grade material, and wherein the valve body comprises an inlet port, an outlet port, and a seat; and a movable member mounted to the actuator shaft, wherein the movable member is made of a flexible thermoplastic food grade elastomer, wherein (i) when the linear actuator is unactuated, the spring biases the actuator shaft and the movable member in the distal direction to be seated at the seat within the valve body, thereby blocking fluid flow from the inlet port to the outlet port, and (ii) when the linear actuator is activated, the actuator shaft and the movable member move in a proximal direction, thereby forming a flow area within the valve body, allowing fluid flow from the inlet port to the outlet port.

EEE 2 is the valve of EEE 1, wherein the movable member has an external annular groove in which a radial seal is disposed, and wherein the radial seal is configured as an integrated molded wiper seal disposed around the movable member to seal and isolate wetted areas between the valve body and the actuator assembly.

EEE 3 is the valve of any of EEEs 1-2, wherein the movable member is configured as a one-piece molded food grade thermoplastic elastomer.

EEE 4 is the valve of any of EEEs 1-3, wherein the movable member has a tapered exterior surface, wherein the seat has an tapered interior surface, wherein when the actuator shaft and the movable member mounted thereto are fully-extended in the distal direction, the movable member is partially received within the seat such that the tapered exterior surface of the movable member interfaces with the tapered interior surface of the seat, facilitating self-centering of the movable member within the seat and forming a tight seal in ice and slushy environments.

EEE 5 is the valve of any of EEEs 1-4, wherein the valve body is coupled to the actuator body via a bayonet attachment.

EEE 6 is the valve of EEE 5, wherein the bayonet attachment involves a push-and-twist and lock action to couple the valve body to the actuator assembly.

EEE 7 is the valve of any of EEEs 1-6, wherein the valve body comprises: a longitudinal portion coupled to the actuator body such that the longitudinal portion is aligned longitudinally with the actuator assembly; and a transversal portion that is perpendicular to the longitudinal portion.

EEE 8 is the valve of EEE 7, wherein the transversal portion comprises the inlet port and the outlet port.

EEE 9 is the valve of EEE 7, wherein the transversal portion comprises the inlet port, and wherein the longitudinal portion comprises the outlet port.

EEE 10 is the valve of any of EEEs 1-9, wherein the valve body comprises: a slot configured to vent fluid to the outlet port when when the movable member is seated at the seat at an end of stroke of the actuator shaft.

EEE 11 is the valve of any of EEEs 1-10, wherein the actuator body has a port for receiving gas to actuate the linear actuator and move the actuator shaft in the proximal direction.

EEE 12 is the valve of any of EEEs 1-11, wherein the movable member is mounted to the actuator shaft via a quick-attach feature.

EEE 13 is the valve of any of EEEs 1-12, wherein the movable member is configured as a plunger.

EEE 14 is the valve of any of EEEs 1-12, wherein the movable member is configured as a blade of a gate valve.

EEE 15 is the valve of any of EEEs 1-12, wherein the movable member is configured as a poppet.

EEE 16 is the valve of EEE 15, wherein the poppet has a distal annular protrusion, and wherein the valve body comprises an annular groove in which the distal annular protrusion of the poppet is received when the linear actuator is unactuated and the poppet is in a fully-extended position.

EEE 17 is the valve of any of EEEs 1-16, wherein the linear actuator is operable by a single input from a user.

EEE 18 is a frozen beverage dispensing equipment comprising: a refrigeration system configured to keep a beverage mixture at a particular temperature to form ice crystals; a mixing mechanism configured to continually stir the beverage mixture to maintain a consistent texture and prevent large ice chunks from forming; one or more storage tanks that store the beverage mixture before the beverage mixture is frozen and dispensed; a dispensing nozzle configured to allow a user to pour the beverage mixture from the one or more storage tanks into a cup; and the valve of any of EEEs 1-17 controlling flow of the beverage mixture from the dispensing nozzle.

EEE 19 is a method of operating the valve of any of EEEs 1-17 or the frozen beverage dispensing equipment of EEE 18.

EEE 20 is a method of assembling the valve of any of EEEs 1-17.

What is claimed is:

1. A valve for frozen beverage dispensing equipment, the valve comprising:
an actuator assembly comprising: (i) an actuator body, (ii) a linear actuator disposed within the actuator body, (iii) an actuator shaft coupled to the linear actuator, and (iv) a spring applying a biasing force on the actuator shaft in a distal direction;
a valve body that is made of a molded composite food grade material, and wherein the valve body comprises an inlet port, an outlet port, and a seat; and
a movable member mounted to the actuator shaft, wherein the movable member is made of a flexible thermoplastic food grade elastomer, wherein (i) when the linear actuator is unactuated, the spring biases the actuator shaft and the movable member in the distal direction to be seated at the seat within the valve body, thereby blocking fluid flow from the inlet port to the outlet port, and (ii) when the linear actuator is activated, the actuator shaft and the movable member move in a proximal direction, thereby forming a flow area within the valve body, allowing fluid flow from the inlet port to the outlet port.

2. The valve of claim 1, wherein the movable member has an external annular groove in which a radial seal is disposed, and wherein the radial seal is configured as an integrated molded wiper seal disposed around the movable member to seal and isolate wetted areas between the valve body and the actuator assembly.

3. The valve of claim 1, wherein the movable member is configured as a one-piece molded food grade thermoplastic elastomer.

4. The valve of claim 1, wherein the movable member has a tapered exterior surface, wherein the seat has an tapered interior surface, wherein when the actuator shaft and the movable member mounted thereto are fully-extended in the distal direction, the movable member is partially received within the seat such that the tapered exterior surface of the movable member interfaces with the tapered interior surface of the seat, facilitating self-centering of the movable member within the seat and forming a tight seal in ice and slushy environments.

5. The valve of claim 1, wherein the valve body is coupled to the actuator body via a bayonet attachment.

6. The valve of claim 5, wherein the bayonet attachment involves a push-and-twist and lock action to couple the valve body to the actuator assembly.

7. The valve of claim 1, wherein the valve body comprises:
a longitudinal portion coupled to the actuator body such that the longitudinal portion is aligned longitudinally with the actuator assembly; and
a transversal portion that is perpendicular to the longitudinal portion.

8. The valve of claim 7, wherein the transversal portion comprises the inlet port and the outlet port.

9. The valve of claim 7, wherein the transversal portion comprises the inlet port, and wherein the longitudinal portion comprises the outlet port.

10. The valve of claim 1, wherein the valve body comprises:
a slot configured to vent fluid to the outlet port when the movable member is seated at the seat at an end of stroke of the actuator shaft.

11. The valve of claim 1, wherein the actuator body has a port for receiving gas to actuate the linear actuator and move the actuator shaft in the proximal direction.

12. The valve of claim 1, wherein the movable member is mounted to the actuator shaft via a quick-attach feature.

13. The valve of claim 1, wherein the movable member is configured as a plunger.

14. The valve of claim 1, wherein the movable member is configured as a blade of a gate valve.

15. The valve of claim 1, wherein the movable member is configured as a poppet.

16. The valve of claim 15, wherein the poppet has a distal annular protrusion, and wherein the valve body comprises an annular groove in which the distal annular protrusion of the poppet is received when the linear actuator is unactuated and the poppet is in a fully-extended position.

17. The valve of claim 1, wherein the linear actuator is operable by a single input from a user.

18. A frozen beverage dispensing equipment comprising:
a refrigeration system configured to keep a beverage mixture at a particular temperature to form ice crystals;
a mixing mechanism configured to continually stir the beverage mixture to maintain a consistent texture and prevent large ice chunks from forming;
one or more storage tanks that store the beverage mixture before the beverage mixture is frozen and dispensed;
a dispensing nozzle configured to allow a user to pour the beverage mixture from the one or more storage tanks into a cup; and
a valve configured to control flow of the beverage mixture from the dispensing nozzle, wherein the valve comprises:
an actuator assembly comprising: (i) an actuator body, (ii) a linear actuator disposed within the actuator body, (iii) an actuator shaft coupled to the linear actuator, and (iv) a spring applying a biasing force on the actuator shaft in a distal direction,
a valve body that is made of a molded composite food grade material, and wherein the valve body comprises an inlet port receiving the beverage mixture, an outlet port coupled to the dispensing nozzle, and a seat, and
a movable member mounted to the actuator shaft, wherein the movable member is made of a flexible thermoplastic food grade elastomer, wherein (i) when the linear actuator is unactuated, the spring biases the actuator shaft and the movable member in the distal direction to be seated at the seat within the valve body, thereby blocking flow of the beverage mixture from the inlet port to the outlet port, and (ii) when the linear actuator is activated, the actuator shaft and the movable member move in a proximal direction, thereby forming a flow area within the valve body, allowing flow of the beverage mixture from the inlet port to the outlet port.

19. A method of assembling a valve configured for dispensing frozen beverage dispensing equipment, the method comprising:
providing an actuator assembly comprising: (i) an actuator body, (ii) a linear actuator disposed within the actuator body, (iii) an actuator shaft coupled to the linear actuator, and (iv) a spring applying a biasing force on the actuator shaft in a distal direction;
mounting a movable member to the actuator shaft via a quick-attach feature, wherein the movable member is made of a flexible thermoplastic food grade elastomer;
mounting a valve body to the actuator body, wherein the valve body is made of a molded composite food grade material, and wherein the valve body comprises an inlet port, an outlet port, and a seat;
actuating the linear actuator, causing the actuator shaft and the movable member to move in a proximal direction, thereby forming a flow area within the valve body, allowing fluid flow from the inlet port to the outlet port; and
un-actuating the linear actuator, causing the spring to bias the actuator shaft and the movable member in the distal direction to be seated at the seat within the valve body, thereby blocking fluid flow from the inlet port to the outlet port.

20. The method of claim 19, wherein mounting the valve body to the actuator body comprises:
mounting the valve body to the actuator body using a push-and-twist and lock action.
